(19) United States
(12) Patent Application Publication
(10) Pub. No.: US 2005/0149345 A1
(43) Pub. Date: Jul. 7, 2005

(54) Utility management system

(75) Inventor: William Mark Daily, Denver, CO (US)

Correspondence Address: LEFFERT JAY & POLGLAZE, P.A., P.O. BOX 581009, MINNEAPOLIS, MN, 55458-1009, US

(73) Assignee: NorthWrite, Inc.

(21) Appl. No.: 10/751,759

(22) Filed: Jan. 5, 2004

(51) Int. Cl. G06F 17/60

(52) U.S. Cl. 705/1

(57) ABSTRACT

A remote site measures utility data and pushes the data to a processing site. The processing site processes the utility data into a utility usage report that takes into account customer desired spreadsheets, setup parameters, and utility tariff data. The usage report is pushed to the customer or other recipient in the form of an email or other communication.

### BACKGROUND OF THE INVENTION

I. Field of the Invention

The present invention relates generally to utilities management. Particularly, the present invention relates to utilities use notification.

II. Description of the Related Art

Commercial utilities users (e.g., office buildings, retail malls) typically desire to know the amount of energy or other utilities that are being consumed during a certain period. The facility manager can then use the information to adjust the operation of the facilities, such as HVAC, lighting, or water, to conserve the utility consumption and, therefore, conserve money.

In the past, a computer may have been used by a facility manager to connect with remote measurement devices over a modem and telephone line connection. This required someone to initiate the connection, access the remote measurement device, and process the data that was received. This is a very maintenance intensive method in that it required someone to actually perform the steps and if it was not accomplished, the data for that particular period was not retrieved leaving a gap in the database of utility usage. Additionally, if the facility manager were responsible for a large number of utility measurement devices, it would be time consuming to call them all to retrieve the data.

Presently, since the Internet is an important resource for the transmission of large amounts of data, the remote utility measurement devices can be connected to the Internet. The facility manager can now access each device over the Internet and retrieve the desired data.

However, it is still time consuming to access each device and wait for a reply of the requested data. If the manager is responsible for a large number of utility measurement devices, the delay for each device is multiplied by the large number of devices. This could result in an inordinate amount of time to gather data. Additionally, the raw data retrieved from the device may be meaningless by itself without further processing.

There is a resulting need in the art to be able to get utility data to a predetermined location or individual with a minimum amount of effort on the part of the utility user.

### SUMMARY

The present invention encompasses a method for utility management. The utility data is acquired from a utility data sensing device such as a utility meter. The data is pushed to a processing device such as a processing site computer. The processing device generates processed utility data that may include a utility report over a predetermined time interval. The processed utility data is pushed to a predetermined location.

The present invention also encompasses a system for performing the utility management methods. The system includes a remote site that has data acquisition hardware coupled to utility sensing devices. The data acquisition hardware acquires the utility data. A receiving device at the remote site receives a formatted utility usage report, from a processing site, that has the acquired utility data after being processed over a predetermined time interval. The processing site has a processing device that generates the formatted report in response to the acquired utility data and certain customer parameters. An email reporting engine generates an email containing the utility usage report.

### BRIEF DESCRIPTION OF THE DRAWINGS

FIG. 1 shows a block diagram of one embodiment of a utility management system of the present invention.

FIG. 2 shows a flow chart of one embodiment of the utility management acquisition method of the present invention.

FIG. 3 shows a flow chart of one embodiment of the utility management processing method of the present invention.

FIG. 4 shows a flow chart of an alternate embodiment of the utility management processing method of the present invention.

FIG. 5 shows one embodiment of an email in accordance with the embodiments of the utility management methods of the present invention.

FIGS. 6A and 6B show embodiments of interval data formatting in accordance with the methods of the present invention.

FIGS. 7A and 7B show embodiments of a periodic utility report in accordance with the methods of the present invention.

### DETAILED DESCRIPTION

The utility management system and methods of the present invention provide utility customers with updates on utility usage. The embodiments of the present invention provide a facility manager or other utility user with up-to-date utility usage data so that corrective actions can be taken if necessary. The updates may be periodic emails or “emergency” emails that inform the utility customer that a predetermined usage threshold has been exceeded.

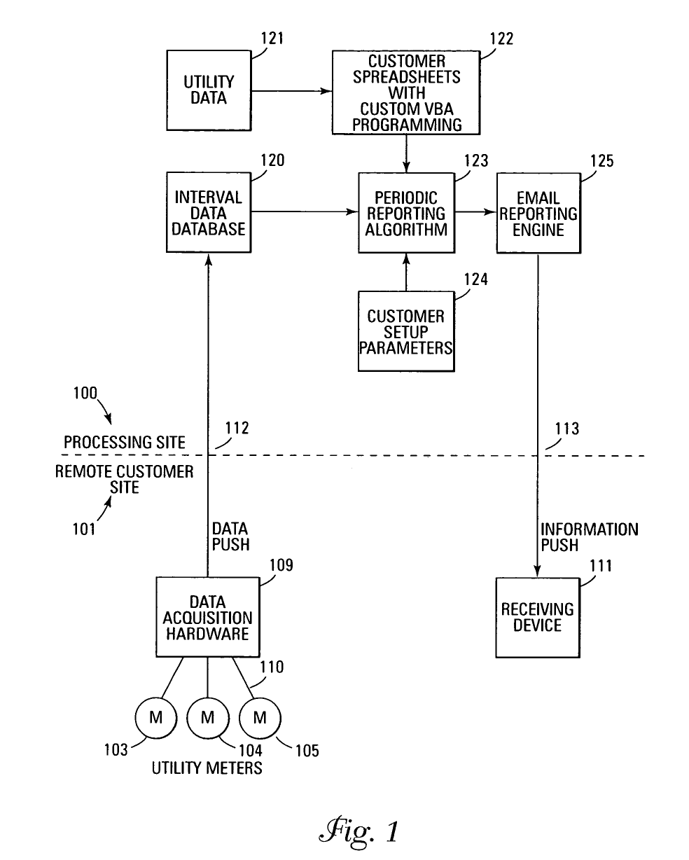

FIG. 1 illustrates a block diagram of one embodiment of the utility management system of the present invention. This figure shows the processing site 100 as well as one remote customer site 101. Only one customer site and one processing site are shown for purposes of clarity. The present invention operates effectively with any number of remote and/or processing sites.

The remote site 101 is comprised of utility data sensing devices such as utility meters 103-105 that measure the amount of the utility that was used within a predetermined period. The type of meter 103-105 and the unit of measurement depend on the utility that is being measured by the present invention. For example, if the utility is electricity service, the electric meters might provide measurement of data in kilowatt-hours. In another embodiment, the utility is water service and the meters might provide data in cubic feet.

The meters of the present invention are not limited to devices that sense and display utility data. A meter describes any device that senses the utility being measured and is able to eventually express that data in a digital or analog format that can be used by the methods of the present invention.

The present invention is not limited to any one type of utility. In fact, the system and method of the present invention is not limited to typical utilities since the data acquisition and information push after processing may be useful for multiple applications. In one embodiment, the present invention monitors any type of building operating data (e.g., energy, maintenance, occupancy)

Data acquisition hardware 109 reads the various meters 103-105 in order to acquire the measured data. In one embodiment, the data acquisition hardware 109 reads all of the meters 103-105 at predetermined intervals that may be periodic. For example, the meters may be read every fifteen minutes.

In another embodiment, the meters 103-105 are read on a priority basis such that meters showing a higher usage are read more frequently. In still another embodiment, the meters 103-105 are read whenever time permits if the data acquisition hardware 109 is busy reading other meters or performing other tasks.

The meters 103-105 can be read over dedicated transmission lines (e.g., wire, fiber optics) between each meter and the data acquisition hardware 109. In another embodiment, each meter can be read over a wireless connection such as infrared, radio frequency, microwave frequency, or a cellular communication network. The meters can also be read manually and entered into the system by an operator. The present invention is not limited to only “electronic” reading of the meter data.

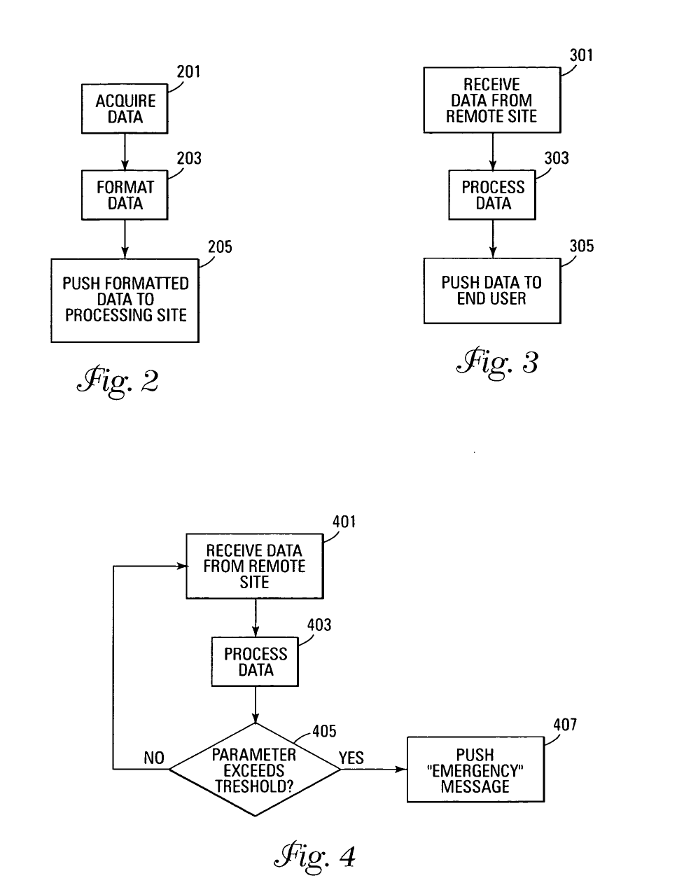

The data acquisition hardware 109, in one embodiment, is comprised of a computer that has ports for receiving data and executes an acquisition/formatting method such as the embodiment illustrated in FIG. 2. The data acquisition hardware 109 also comprises communication hardware to communicate with the processing site 100 over a data line 112. The type of communication hardware depends on the connection between the processing site 100 and the remote site 101. In another embodiment, the data acquisition function may be included in the utility data sensing devices 103-105.

The remote site 101 is additionally comprised of a receiving device 111 that receives the formatted data from the processing site 100. In one embodiment, the receiving device 111 is a computer that executes an email program and receives the formatted data as an email with an attachment that is pushed from the processing site 100 over a data connection 113. The attachment may be in a spreadsheet format such as that provided by MICROSOFT EXCEL or some other type of formatting. In alternate embodiments, the receiving device 111 is a cellular telephone, a personal digital assistant (PDA), palm computing device, or any other type of portable wireless communication device.

The data connections 112 and 113 between the processing site 100 and the remote site 101 can be the Internet or a dedicated network between the two sites 100 and 101. The connections 112 and 113 may also be wireline networks or wireless networks. The present invention is not limited to any one type of communication method or protocol between the two sites 100 and 101.

In one embodiment, the processing site 100 is a computer server located in a central location that handles the data from multiple remote sites 101. In other embodiments, the central location may have multiple networked servers in order to handle a large number of remote sites. Additionally, the various functions of the processing site may be spread among multiple computers. For example, one computer may handle processing of the interval data while another computer handles the email generation and communication between the processing site and the remote sites.

The processing site 100 comprises a database 120 that contains the interval utility data from the remote site 101. The database 120 may store the data in the format in which it was received or in other formats. In one embodiment, the data is received in MICROSOFT EXCEL formatting as an attachment to an email.

A periodic reporting algorithm 123 is executed by the processing site 100 to generate the utility information emails that are pushed to the remote site 101. The reporting algorithm 123 uses the interval data from the interval database 120, customer setup parameters 124, and customer spreadsheets 122 formed from utility data 121.

The utility data 121 includes information specific to each utility. For example, the utility data 121 may include tariff structures for electricity or water. If there are multiple utility providers for each utility, the utility data 121 includes data for each provider. When the tariff rates or other utility data 121 is changed, it is updated either by the utility provider pushing the updated information to the processing site 100 or the processing site 100 reading the updated data from another database.

The customer spreadsheet block 122 uses the utility data 121 to generate spreadsheets of the utility data that are updated automatically when the utility data is updated. In one embodiment, the customer spreadsheet block 122 includes custom visual basic application programming to customize each spreadsheet to a particular customer's parameters. The spreadsheet may be in a format compatible with MICROSOFT EXCEL or it may be in another format.

The customer setup parameters 124 provide the periodic reporting algorithm 123 with customer information that is specific to each customer. This may include the times that the customer desires a utility report to be generated, email addresses to which the emails will be pushed, and information that is to be included in the report. The customer setup parameters are not limited to any certain set of report parameters.

The email reporting engine 125 is an email client program that takes the utility report from the reporting algorithm 123 and pushes it to the customer over the data connection 113. The email reporting engine 125, in one embodiment, sends the report as an attachment. In another embodiment, the report is included in the body of the email. In still another embodiment, the report is summarized in the email subject line so that the pertinent information is more rapidly available.

While the above-described embodiment of FIG. 1 relies on the pushing of the data from one site 100 or 101 to the other 101 or 100, the data can also be read from the remote site 101 by the processing site 100. Additionally, the processed and formatted data can be read by the remote site 101 from the processing site 100 instead of receiving a pushed data communication.

In yet another embodiment, the functions performed by the processing site may be performed by the remote site such that a central processing function is not required. Additionally, the reporting functions may be split amongst the various system components, depending on the processing required, the analysis performed, and the degree of sophistication of the report.

FIG. 2 illustrates a flow chart of one embodiment of the utility management acquisition method of the present invention. This method can be executed by the data acquisition hardware that was discussed above in relation to FIG. 1.

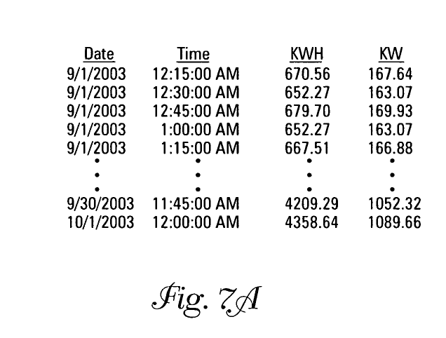

The method acquires the data 201 and formats it 203 for transmission. The formatting may be in a spreadsheet format (e.g., EXCEL) or some other type of formatting that is known or can be interpreted by the processing site. One embodiment for the formatting used in an email of the present invention is illustrated in FIGS. 6A and 6B and discussed subsequently.

The data is then pushed in email format to the processing site for processing 205. In an alternate embodiment, this step 205 is replaced by the step of the processing site reading the data to be processed instead of the data being pushed.

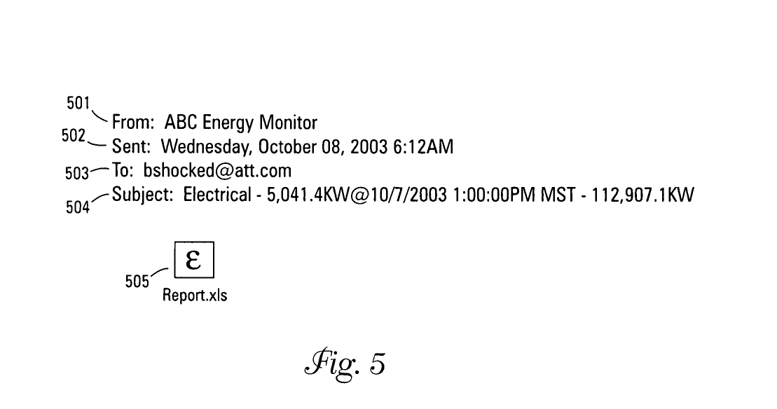

FIG. 3 illustrates a flow chart of one embodiment of the utility management processing method of the present invention. This method may be executed by the processing site.

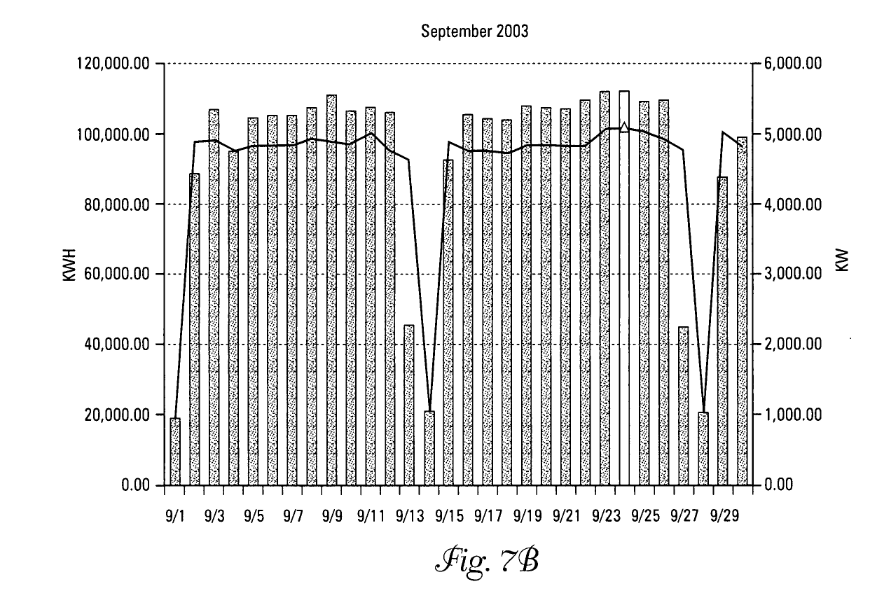

The data is received or read, depending on the embodiment, from the remote site 301. The processing site periodic reporting algorithm processes the data 303 according to the customer's rules in order to generate the utility usage reports that are pushed to the end user (e.g., utility customer) 305. This processing is described above with reference to FIG. 1. Examples of formats of utility usage reports of the present invention are illustrated in FIGS. 7A and 7B and are discussed subsequently.

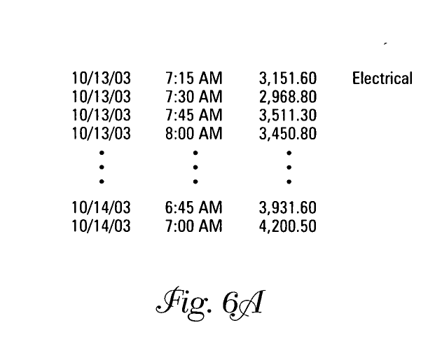

FIG. 4 illustrates a flow chart of an alternate embodiment of the utility management processing method of the present invention. This embodiment is substantially similar to the embodiment of FIG. 3 in that the data is either received or read 401 from the remote site and processed according to the utility customer's specific formatting 403. However, in this embodiment, the utility customer has provided the processing site with a utility parameter threshold that the processed data is compared against 405. The processing site then generates an “emergency” email or other data structure that is pushed to the customer when this threshold is exceeded 407.

Exceeding the threshold may occur if the utility parameter is above or below the predetermined threshold. This could occur, for example, if the utility customer needs to know immediately about an electricity usage reading above a certain level of kilowatt-hours or water usage above a certain cubic feet per minute. Such an embodiment could transmit the data to a cell phone, personal digital assistant, palm computer, or other portable wireless device.

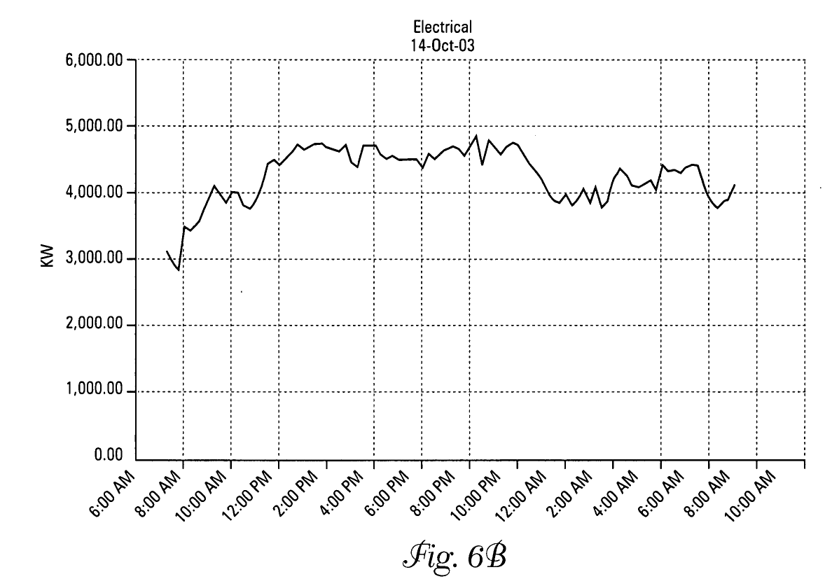

FIG. 5 illustrates one embodiment of an email of the present invention. This email format may be used both from the remote site to the processing site and from the processing site to the customer's desired email addresses. The only differences between the two emails may be the information contained in the subject line and the attached reports, as discussed subsequently.

This email includes who the email is from 501, the date/time it was sent 502, the recipient's email address 503, and the subject line 504. In this embodiment, the subject line includes a summary of the recent electrical utility usage during a predetermined interval. The subject line in FIG. 5 shows a usage of 5,041.1 kW at 1:00:00 PM MST on Oct. 7, 2003. Additionally, an average usage of 112,907.1 kWh was used over a period that was specified by the customer in the customer setup parameters discussed previously with reference to FIG. 1.

FIG. 5 also shows an attachment 505 of a utility usage report in the EXCEL format. The content of such a report will depend on whether the email is from the remote site prior to being processed or from the processing site after processing of the interval utility data. Alternate embodiments may not include this report, include it in the body of the email, or use a different format.

FIG. 6A illustrates one embodiment of a listing of interval utility data that was gathered by the data acquisition hardware of FIG. 1. For purposes of clarity, FIG. 6A shows only a partial listing for a 24-hour period. This listing includes the date and time that the meter reading was accomplished as well as the meter reading at that point. In the embodiment of FIG. 6A, the utility being measured is electricity and the meter reading is in kilowatts. Alternate embodiments may have readings for other utilities such as water and gas. Still other embodiments may use different data reading time intervals than 15 minutes and/or different periods over which the readings are taken.

FIG. 6B illustrates a graph of the data listed in FIG. 6A over a 24 hour period. This graph includes time along the x-axis and kilowatts along the y-axis.

FIG. 7A illustrates one example of a report that is pushed to a utility customer after processing of the interval utility data at the processing site. For purposes of clarity, FIG. 7A shows only a partial listing of data for the month long period that the report covers.

This report is a listing of the interval data over a predetermined period. In the present embodiment, the predetermined period is a one month period and the data is presented in kilowatts for a particular time on a particular day and the kilowatt-hours used at that time.

FIG. 7B illustrates a graph of the data listed in FIG. 7A over the month time period. The x-axis displays the data of the month, the left side of the y-axis shows the kilowatt-hours used, and the right side of the y-axis displays the kilowatts used on that date. The bar graphed data shows the kilowatt-hours for each day and the line plot displays the kilowatts.

The formats listed in FIGS. 5, 6A, 6B, 7A, and 7B are for purposes of illustration only. The present invention is not limited to any one format for the emails of the attached reports. Nor is the present invention limited to any one spreadsheet software.

The utilities of the present invention can include typical utilities such as water, electricity, gas, and sewage. However, the present invention is not limited to just “typical” utilities. Alternate embodiments may include other services such as cable television usage, satellite television usage, cable data usage, Internet Service Provider usage, or the use of any other service that can be measured and monitored as described herein.

In summary, the embodiments of the utility management system and method of the present invention provide a utility customer with up-to-date reports on utility usage. These reports may be periodic, at a time chosen by the utility customer, or whenever the utility usage exceeds a predetermined threshold. These reports enable the facility manager or other interested party to make monitor and/or make changes to their utility usage in response to the usage patterns that are displayed in the reports.

Numerous modifications and variations of the present invention are possible in light of the above teachings. It is therefore to be understood that within the scope of the appended claims, the invention may be practiced otherwise than as specifically described herein.

1. A method for utility management comprising:
acquiring utility data;
processing the acquired utility data into processed utility data; and
pushing the processed utility data to a predetermined location.

2. The method of claim 1 wherein acquiring the utility data includes reading a utility data sensing device that senses utility data.

3. The method of claim 1 wherein the utility data includes electricity, water, gas, sewage, cable television, satellite television, maintenance, occupancy, and Internet usage data.

4. The method of claim 1 and further including:
formatting the acquired utility data; and
pushing the acquired utility data to a processing device.

5. The method of claim 4 wherein the processing device is a computer device.

6. The method of claim 1 wherein processing the acquired utility data includes:
generating a utility report in response to predetermined parameters; and
generating an email containing the utility report.

7. The method of claim 1 wherein pushing the processed utility data comprises transmitting an email to the predetermined location.

8. The method of claim 4 wherein formatting the acquired utility data includes inputting the acquired utility data into a data spreadsheet.

9. The method of claim 6 wherein generating the utility report includes inputting the acquired utility data into a data spreadsheet.

10. A method for utility management comprising:
acquiring utility data from a utility data sensing device;
inputting the acquired utility data to a processing device;
processing the acquired utility data into processed utility data; and
pushing the processed utility data to a predetermined location.

11. A method for utility management comprising:
acquiring utility data from a utility meter;
formatting the acquired utility data into formatted acquired utility data;
pushing the formatted acquired utility data to a processing computer;
generating a utility usage data report in response to the formatted acquired utility data; and
pushing the processed utility data to a predetermined location.

12. The method of claim 11 wherein the formatted acquired utility data is pushed over a wireless connection.

13. The method of claim 11 wherein the processed utility data is pushed over a wireless connection.

14. The method of claim 11 wherein pushing comprises an emailing operation.

15. The method of claim 14 wherein the emailing operation includes summarizing the utility data in a subject line of an email.

16. A method for utility management comprising:
acquiring utility data from a utility meter;
formatting the acquired utility data into formatted acquired utility data;
emailing the formatted acquired utility data to a processing computer;
generating a utility usage report in response to the formatted acquired utility data, predetermined report parameters, and utility data; and
emailing the processed utility data to a predetermined email address as an email attachment such that the email includes a summary of the formatted acquired utility data.

17. The method of claim 16 wherein the predetermined report parameters include time intervals over which the utility usage report is generated, email addresses to which the report is transmitted, and information to be included in the report.

18. The method of claim 16 wherein utility data includes tariff data on the utility data.

19. A utility management system comprising:
a remote site comprising:
data acquisition hardware coupled to utility sensing devices, the data acquisition hardware acquiring utility data;
a receiving device that receives a formatted report comprising acquired utility data processed over a predetermined time interval; and
a processing site comprising:
a processing device that generates the formatted report in response to the acquired utility data and customer parameters; and
an email reporting engine that generates an email comprising the formatted report.

20. The system of claim 19 wherein the utility data is acquired over predetermined time intervals.

21. The system of claim 19 wherein the formatted report is an attachment to the email.

22. The system of claim 19 wherein the formatted report is in both spreadsheet and graphical formats.

23. The system of claim 19 wherein the customer parameters comprise the predetermined time interval and an email address for the email.

24. The system of claim 19 wherein the receiving device is a wireless communication device.

25. A utility management system comprising:
a computer device that receives interval utility data and processes the interval utility data into a utility usage report in response to customer setup parameters, tariff data, and customer spreadsheet parameters; and
an email reporting engine that generates and transmits an email, containing the utility usage report, to an address specified in the customer setup parameters.
